(19) United States
(12) Patent Application Publication
(10) Pub. No.: US 2018/0056861 A1
(43) Pub. Date: Mar. 1, 2018

(54) VEHICLE-MOUNTED AUGMENTED REALITY SYSTEMS, METHODS, AND DEVICES

(71) Applicant: BOE Technology Group Co., Ltd., Beijing (CN)

(72) Inventor: Bing chuan Shi, Beijing (CN)

(21) Appl. No.: 15/656,049

(22) Filed: Jul. 21, 2017

(30) Foreign Application Priority Data
Aug. 31, 2016 (CN) 201610795113.4

(51) Int. Cl. B60Q 9/00; H04N 7/18; G06T 7/73; G02B 27/01; G02B 27/22

(52) U.S. Cl. CPC B60Q 9/00; H04N 7/183; G06T 7/74; G02F 1/136277; G02B 27/2228; G02B 2027/0178; G02B 27/0172

(57) ABSTRACT

The present disclosure discloses a vehicle-mounted augmented reality system, method, and device. The system comprises a spectacles device and a vehicle body device. The spectacles device comprises: a receiving module and a projection display module. The receiving module is configured to receive information from the vehicle body device; and the projection display module is configured to perform projection or display based on the received information. The vehicle body device comprises: a motion tracking module, an information acquisition module, a processing module, and a communication module, wherein the motion tracking module is configured to determine a position and/or orientation of the spectacles device, the information acquisition module is configured to acquire vehicle-related information, the processing module is configured to determine, from the acquired information, information to be provided to the spectacles device according to the position and/or orientation of the spectacles device; and the communication module is configured to transmit the determined information to the spectacles device.

### CROSS-REFERENCE TO RELATED APPLICATION(S)

This application claims priority to the Chinese Patent Application No. 201610795113.4, filed on Aug. 31, 2016, entitled “VEHICLE-MOUNTED AUGMENTED REALITY SYSTEMS, METHODS, AND DEVICES,” which is incorporated herein by reference in its entirety.

### TECHNICAL FIELD

Embodiments of the present disclosure relate to the field of information technology, and more particularly, to vehicle-mounted augmented reality systems, methods, and devices.

### BACKGROUND

In recent years, with rapid development of electronic technology and image processing technology, visual systems are widely used in various industries. For example, in the transportation industry, a Head-Up Display (HUD) device may provide a driver with richer information to ensure driving safety. However, the head-up display device also has obvious disadvantages, for example, the head-up display device occupies a large interior space of a vehicle at the expense of a space of passengers; a visible area of the head-up display device is fixed as the head-up display device is fixed relative to a vehicle body, and an image generated by the head-up display device may produce a significant jitter relative to an observer when the vehicle is in a bump state; a front loading device of the head-up display device needs to match a windshield of the vehicle, which is difficult to realize, and a rear loading device of the head-up display device has a small display area due to a limited display space and thus has poor man-machine efficiency etc.

Display systems of augmented reality spectacles in the consumer market are relatively mature, but have limited application scenarios due to the limitations of computing power, capability to capture motions etc. of wearable small-sized devices. Further, due to the constraints of power consumption and battery power, it is difficult to balance duration of flight and power volume. In general, the augmented reality spectacles are still relatively cumbersome to be used as portable devices, have poor user experience, and are also not suitable for vehicle-mounted environments.

### SUMMARY

In order to at least partially solve or mitigate the above problems, a vehicle-mounted augmented reality system, method and device according to the embodiments of the present disclosure are proposed.

According to an aspect of the present disclosure, there is disclosed a vehicle-mounted augmented reality system. The vehicle-mounted augmented reality system comprises a spectacles device and a vehicle body device, wherein the spectacles device comprises a receiving module and a projection display module, wherein the receiving module is configured to receive information from a vehicle body device; and the projection display module is configured to project or display based on the received information; and the vehicle body device comprises a motion tracking module, an information acquisition module, a processing module, and a communication module, wherein the motion tracking module is configured to determine a position and/or orientation of the spectacles device; the information acquisition module is configured to acquire vehicle-related information; the processing module is configured to determine, from the acquired information, information to be provided to the spectacles device according to the position and/or orientation of the spectacles device; and the communication module is configured to transmit the determined information to the spectacles device.

In an embodiment, a left eye portion and/or a right eye portion of the spectacles device has the projection display module.

In an embodiment, the projection display module comprises a micro-LCoS display apparatus and a virtual image projection lens, and the spectacles device is capable of providing a stereoscopic image to a user in a case where each of the left eye portion and the right eye portion of the spectacles device has the projection display module.

In an embodiment, the spectacles device further comprises at least one of: an image acquisition module configured to acquire an image; and a motion detection module configured to detect motion information of the spectacles device.

In an embodiment, the spectacles device is powered by the vehicle body device.

In an embodiment, the information acquisition module comprises at least one of: an image capture module configured to capture an image, and a movement data acquisition apparatus configured to acquire data related to operations of the vehicle, wherein the information acquisition module is further configured to obtain vehicle-related information from a network via the communication module.

In an embodiment, the image capture module is configured to be capable of capturing an external image of the vehicle, and the processing module is configured to determine an external image of the vehicle corresponding to the position and/or orientation of the spectacles device as the information to be provided to the spectacles device when the spectacles device is directed to an occlusion area.

In an embodiment, the processing module is configured to determine the external image of the vehicle corresponding to the position and/or orientation of the spectacles device based on an image acquired by the image acquisition module of the spectacles device and/or motion information detected by the motion detection module of the spectacles device.

In an embodiment, the motion tracking module is configured to determine the position and/or orientation of the spectacles device by one of: the motion tracking module determining the position and/or orientation of the spectacles device based on the image of the spectacles device obtained from the image capture module; the motion tracking module determining the position and/or orientation of the spectacles device based on the motion information of the spectacles device received from the spectacles device; or the motion tracking module determining the position and/or orientation of the spectacles device based on the motion information of the spectacles device received from the spectacles device and the image of the spectacles device obtained from the image capture module.

In an embodiment, the information processing module is configured to provide information related to a received instruction to the spectacles device based on the instruction.

In an embodiment, the information comprises one or more of: vehicle status information; surrounding environment information; traffic information; route planning information; recommendation information; and prompt information.

According to a second aspect of the present disclosure, there is provided a vehicle-mounted augmented reality method. The method comprises: receiving, at a spectacles device, information which is determined based on a position and/or orientation of the spectacles device from a vehicle body device; and performing, at the spectacles device, displaying or projection based on the received information.

According to a third aspect of the present disclosure, there is provided a vehicle-mounted augmented reality spectacles device. The spectacles device comprises: a receiving module configured to receive, from a vehicle body device, information which is determined based on a position and/or orientation of the spectacles device; and a projection display module configured to perform projection or display based on the received information.

According to a fourth aspect of the present disclosure, there is provided a vehicle-mounted augmented reality method. The method comprises: determining, at a vehicle body device, a position and/or orientation of a spectacles device; acquiring, at the vehicle body device, vehicle-related information; determining, at the vehicle body device, information to be provided to the spectacles device from the acquired information according to the position and/or orientation of the spectacles device; and transmitting, at the vehicle body device, the determined information to the spectacles device.

According to a fifth aspect of the present disclosure, there is provided a vehicle-mounted augmented reality vehicle body device. The vehicle body device comprises a motion tracking module, an information acquisition module, a processing module and a communication module, wherein the motion tracking module is configured to determine a position and/or orientation of a spectacles device; the information acquisition module is configured to acquire vehicle-related information; the processing module is configured to determine, from the information acquired by the information acquisition module, information to be provided to the spectacles device according to the position and/or orientation of the spectacles device; and the communication module is configured to transmit the determined information to the spectacles device.

### BRIEF DESCRIPTION OF THE DRAWINGS

Reference is now made to the accompanying drawings, which are only exemplary and not necessarily drawn to scale, wherein:

FIG. 1 schematically illustrates a block diagram of a vehicle-mounted augmented reality system according to an example embodiment of the present disclosure.

FIG. 2 schematically illustrates a block diagram of a spectacles device according to an embodiment of the present disclosure.

FIG. 3 schematically illustrates a block diagram of a spectacles device according to another embodiment of the present disclosure.

FIG. 4 schematically illustrates a block diagram of a vehicle body device according to an embodiment of the present disclosure.

FIG. 5 illustrates a flowchart of a vehicle-mounted augmented reality method according to an embodiment of the present disclosure.

FIG. 6 illustrates a flowchart of a vehicle-mounted augmented reality method according to an embodiment of the present disclosure.

In the accompanying drawings, for ease of understanding, elements that have substantially the same or similar structures and/or the same or similar functions are indicated by the same or similar reference signs.

### DETAILED DESCRIPTION

Embodiments of the present disclosure will now be described with reference to the accompanying drawings. In the following description, numerous specific details are set forth so that those skilled in the art will more fully understand and practice the present disclosure. It will be apparent to those skilled in the art that the embodiments of the present disclosure can be practiced without some specific details in these specific details. In addition, it is to be understood that the disclosure is not limited to the particular embodiments described. Rather, it is contemplated that embodiments of the present disclosure can be practiced with any combination of features and elements described below. Accordingly, the following aspects, features, embodiments and advantages are for illustrative purposes only and are not to be regarded as an element or limitation of the claims, unless expressly stated in the claims.

Throughout the present disclosure, the same reference signs refer to the same elements. As used herein, terms “data”, “content”, “information” and/or the like are used interchangeably to refer to data which can be transmitted, received and/or stored in accordance with the embodiments of the present disclosure. Accordingly, the use of any such words should not be construed as limiting the spirit and scope of the embodiments of the present disclosure.

In addition, as used herein, a word “circuit” refers to: (a) a hardware circuit implementation only (for example, an implementation in an analog circuit and/or a digital circuit); (b) combinations of a circuit and computer program product(s), comprising: software and/or firmware instructions stored on one or more computer-readable memories that work together to cause an apparatus to perform one or more of the functions described herein, and (c) a circuit (such as, for example, a microprocessor(s) or a portion of the microprocessor(s)) which is required to be used for running software or firmware, even if the software or firmware is not physically presented. This definition of the “circuit” is used throughout this present disclosure (including any claim). As a further example, as used herein, the word “circuit” also comprises an implementation which comprises one or more processors and/or a portion(s) thereof and is accompanied by software and/or firmware.

It is to be noted that the term “vehicle-mounted” as used herein is not limited to automobiles, but may encompass any system and product which may use the embodiments of the present disclosure. For example, the embodiments of the present disclosure may be applied to any applicable motor vehicle and/or non-motor vehicle, or other application environments etc.

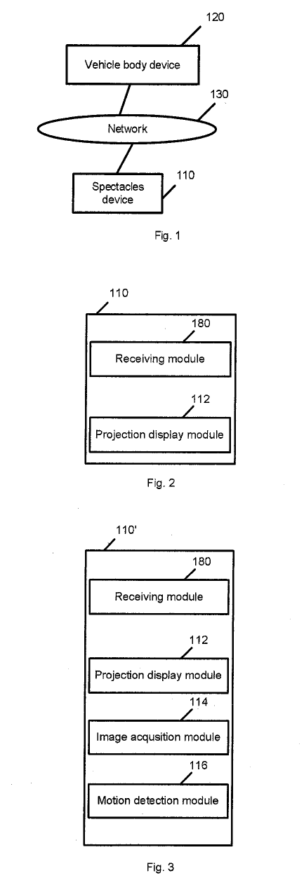

FIG. 1 schematically illustrates a block diagram of a vehicle-mounted augmented reality system 100 according to an embodiment of the present disclosure. The vehicle-mounted augmented reality system 100 may comprise a spectacles device 110 to be worn by a user and a vehicle body device 120 mounted on a vehicle. The spectacles device 110 and the vehicle body device 120 may communicate through a network 130. The network 130 may be any wired network, wireless network, or a combination thereof. The wireless network may comprise any short-range wireless communication network, such as a vehicle-mounted wireless network, a Wireless Local Area Network (WLAN), a Bluetooth network, etc. The wired network may comprise, but is not limited to, the Ethernet, a vehicle wired network, a vehicle bus such as a CAN bus or a k_Line bus etc.

The spectacles device 110 may have any suitable shape and size, and may be worn in any suitable manner. The spectacles device 110 may have two transparent or imperfectly transparent lenses. For example, the lenses of the spectacles may be the same as lenses of conventional spectacles which currently exist, are being developed or will be developed in the future. For example, the lenses of the spectacles may be made of a material such as glass, resin etc. In addition, the lenses of the spectacles may also be made into a display for displaying information to a user. Further, depending on application scenarios or requirements, structures or functions of the two lenses may be the same or different. By way of example, a lens may be a conventional lens, and the other lens may be used as a display or may have a display or a projector installed thereon. As another example, each of the lenses may be used as a display or may have a display or a projector installed thereon, in which case the spectacles device 110 may provide a stereoscopic image to the user.

FIG. 2 schematically illustrates a block diagram of a spectacles device 110 according to an embodiment of the present disclosure. As shown in FIG. 2, in an embodiment, the spectacles device 110 comprises a receiving module 180 and a projection display module 112, wherein the receiving module 180 receives information from a vehicle body device, and the projection display module 120 projects or displays the information received from the vehicle body device for view by a user. The receiving module may be any receiving apparatus capable of receiving information from the vehicle body device 120, which currently exists, is being developed or will be developed in the future. For example, the receiving module may be implemented using any applicable wired and/or wireless technology. A left eye portion (for example, a left lens) and/or a right eye portion (for example, a right lens) of the spectacles device may have a projection display module. By way of example, the projection display module may be mounted on one or two lenses of the spectacles device 110 and may be a micro-display or a micro-projector. For example, in a case that the projection display module 112 is a display, it may be a stand-alone device and mounted on a lens, or it may be integrated with the lens, for example, a part of the lens or the entire lens is a display. As another example, in a case that the projection display module 112 is a projector, it may be mounted on one or two lenses. In a case that the projection display module 112 is mounted on two lenses, it may comprise two stand-alone projection display modules 112.

The projection display module 112 may use any applicable projection technology or display technology which currently exists, is being developed or will be developed in the future to project and display the information.

The information received from the vehicle body device may comprise any suitable information. In an embodiment, the information received from the vehicle body device may be one or more of: vehicle status information, surrounding environment information, traffic information, route planning information, recommendation information, and prompt information. For example, the vehicle status information may comprise a speed, a direction, acceleration, a fuel capacity, an engine condition, and vehicle body inclination etc. of a vehicle. The surrounding environment information may comprise a distribution condition of surrounding vehicles/pedestrians/any other objects, environment information (for example, weather conditions, etc.) etc. The traffic information may comprise traffic information collected by the vehicle per se and/or traffic information obtained from various traffic information platforms/systems etc. The route planning information may be used to comprise traffic planning information from various traffic planning applications. The recommendation information may be information recommended based on a user preference, a position, a vehicle status, an environment, a climate, etc. The recommendation information may be from a system of the vehicle per se or may be obtained through a network. The prompt information may comprise a variety of appropriate prompt information, such as a danger prompt, an over-speed prompt, a low speed prompt, a traffic violation prompt, a current time/weather prompt, prompt information based on various conditions (e.g., a position) etc. The prompt information may be prompt information from the vehicle per se and/or a system/application of a network.

In other embodiments, the information received from the vehicle body device 120 may be different, for example, depending on application scenarios and user requirements etc. of the spectacles device 110.

In an embodiment, the projection display module 112 may comprise a micro Liquid Crystal on Silicon (LCoS) display apparatus and a virtual image projection lens, which may perform projection based on the information received from the vehicle body device 120 to allow the user to view related content, for example, the information is projected to a virtual image a certain distance away from the front of a driver. The micro LCoS display apparatus and the virtual image projection lens may be any micro LCoS display apparatus and virtual image projection lens which currently exist, are being developed or will be developed in the future.

In an embodiment, in a case that the left eye portion and the right eye portion of the spectacles device 110 have the projection display module 112, the spectacles device 110 is capable of providing a stereoscopic image to the user. For example, the projection display module 112 of the left eye portion and the projection display module 112 of the right eye portion may display/project an image having a certain parallax respectively to form a stereoscopic image.

In an embodiment, the receiving module 180 may receive information associated with the bearing (for example, position and/or orientation) of the spectacles device 110 from the vehicle body device 120, and the projection display module 112 may display/project related content to the user based on the information associated with the bearing of the spectacles device 110.

In the embodiments described with reference to FIGS. 1 and 2, the spectacles device 110 may have only the projection display module 112 and other necessary elements, in which case a number of elements of the spectacles device 110 can be reduced so that the spectacles device 110 is more portable.

FIG. 3 schematically illustrates a block diagram of a spectacles device 110′ according to another embodiment of the present disclosure. As shown in FIG. 3, in an embodiment, in addition to the projection display module 112 and the receiving module 180, the spectacles device 110′ further comprises at least one of: an image acquisition module 114 which acquires an image for use by the vehicle body device 120; and a motion detection module 116 which detects motion information of the spectacles device 110′ for use by the vehicle body device 120.

The image acquisition module 114 may be any suitable device capable of acquiring/obtaining an image. For example, the image acquisition module 114 may be an image sensor. The image acquisition module 114 may be placed at any suitable position of the spectacles device 110′. For example, the image acquisition module 114 may be placed on a frame or a leg of the spectacles, at a junction of two frames of the spectacles, or any other suitable position. The image acquisition module 114 may acquire any suitable image, such as images in front of, behind, on the side of, above and below the spectacles device, depending on application scenarios and user requirements etc. In addition, the image acquisition module 114 may be one or more image acquisition modules 114. In an embodiment, the image acquisition module 114 may acquire an image in front of the spectacles device 110′ for use by the vehicle body device 120. For example, the vehicle body device 120 may use the image to determine a field of view/bearing etc. of the spectacles device 110′.

The motion detection module 116 may comprise any suitable motion sensor, such as a distance sensor, an angle sensor, an accelerometer, a micro gyroscope, and any other suitable sensor capable of detecting motion information. The motion information of the spectacles device 110′ may comprise a distance from the spectacles device 110′ to each reference object, an inclination angle or an acceleration of the spectacles device 110′ etc. The motion detection module 116 may provide the obtained original information or the processed information to the vehicle body device 120.

In addition, the spectacles device 110′ may further comprise a communication apparatus which communicates with the vehicle body device or other devices. For example, the image acquired by the image acquisition module 114 and the motion information of the spectacles device 110′ detected by the motion detection module 116 may be transmitted to the vehicle body device 120 or other devices through the communication apparatus. In addition, the communication apparatus may receive information transmitted from the vehicle body device 120 or other devices, in which case the communication apparatus may comprise a receiving module 180.

In the embodiments described with reference to FIGS. 1 and 3, in addition to the projection display module 112 and the receiving module 180, the spectacles device 110′ may further comprise the image acquisition module 114 and the motion detection module 116. In this case, although a number of elements of the spectacles device 110′ increases as compared with the embodiment of FIG. 2, the image acquisition module 114 and the motion detection module 116 may be generally made into micro-elements, and thus the overall weight of the spectacles device 110′ increase slightly. Therefore, additional functions can be provided without significantly increasing the weight of the spectacles device 110′.

In an embodiment, the spectacles device 110 or 110′ may not have a battery device, in which case the vehicle body device may supply power to the spectacles device 110 or 110′. In this embodiment, a number of elements of the spectacles device 110 or 110′ may further be reduced so that the spectacles device 110 or 110′ is more portable. However, in other embodiments, for example, in a case that the vehicle body device 120 is not convenient to supply power to the spectacles device 110 or 110′, the spectacles device 110 or 110′ may also have a battery device.

Referring again to FIG. 1, the vehicle-mounted augmented reality system 110 may further comprise a vehicle body device 120. The vehicle body device 120 may generally be provided on a vehicle or any other suitable device. By way of example, the vehicle body device 120 may be provided on the vehicle or integrated with any suitable one or more devices on the vehicle.

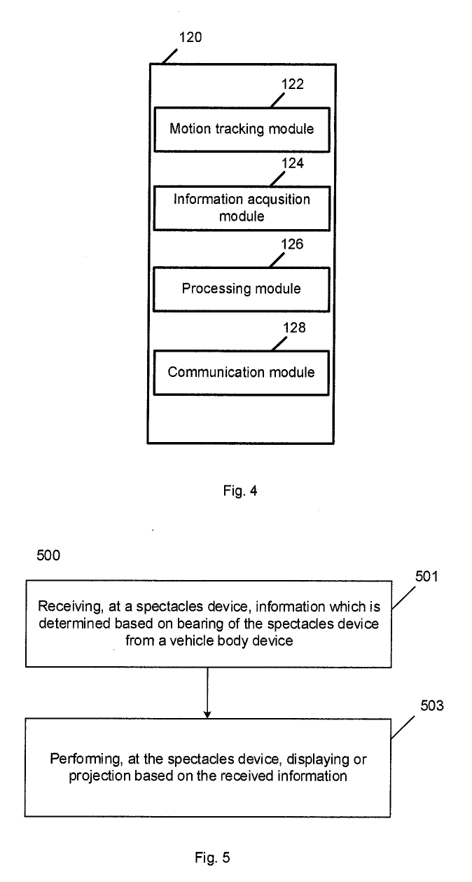

FIG. 4 schematically illustrates a block diagram of the vehicle body device 120 according to an embodiment of the present disclosure. As shown in FIG. 4, the vehicle body device 120 may comprise a motion tracking module 122, an information acquisition module 124, a processing module 126, and a communication module 128, wherein the motion tracking module 122 is used to determine bearing of the spectacles device 110 and/or 110′; the information acquisition module 124 is used to acquire vehicle-related information, the processing module 126 is used to determine, from the information acquired by the information acquisition module 124, information required to be provided to the spectacles device 110 and/or 110′ according to the bearing of the spectacles device 110 and/or 110′; and the communication module 128 is used to transmit the determined information to the spectacles device 110 and/or 110′.

In an embodiment, the motion tracking module 122 may determine the bearing of the spectacles device 110 and/or 110′ according to any suitable motion tracking technology which currently exists, is being developed or will be developed in the future. For example, the motion tracking module 122 may determine the bearing of the spectacles device 110′ according to image information transmitted by the image acquisition module 114 of the spectacles device 110′ and/or motion information of the spectacles device 110′ detected by the motion detection module 116. In addition, the motion tracking module 122 may further comprise a motion sensor capable of determining the bearing of the spectacles device 110 and/or 110′, such as a distance sensor, an image sensor, etc., to determine the bearing of the spectacles device 110 and/or 110′. In an embodiment, the motion tracking module 122 may determine the bearing of the spectacles device 110 and/or 110′ by one of:

1) the motion tracking module 122 determining the bearing of the spectacles device 110 and/or 110′ based on an image of the spectacles device 110 and/or 110′ obtained from the image capture module of the vehicle body device 120. For example, the motion tracking module 122 may determine the bearing of the spectacles device 110 and/or 110′ by processing images obtained at different angles and/or positions for example using any applicable image processing technology, in which case, the spectacles device 110 and/or 110′ may have no motion sensor, thereby reducing the cost and improving the portability of the spectacles device 110 and/or 110′;

2) the motion tracking module 122 determining the bearing of the spectacles device 110 and/or 110′ based on the motion information of the spectacles device received from the spectacles device 110 and/or 110′. For example, as described above, the motion detection module 116 of the spectacles device 110′ may detect the motion information of the spectacles device 110′, so that the motion tracking module 122 may determine the bearing of the spectacles device 110′ based on the motion information of the spectacles device 110′ received from the spectacles device 110′, in which case the motion tracking module 122 may have no motion sensor, thereby reducing the cost;

3) the motion tracking module 122 determining the bearing of the spectacles device 110 and/or 110′ based on the motion information of the spectacles device 110 and/or 110′ received from the spectacles device 110 and/or 110′ and the image of the spectacles device 110 and/or 110′ obtained from the image capture module, in which case, the accuracy of determining the bearing of the spectacles device 110 and/or 110′ can be increased.

Depending on different application scenarios and user requirements, the motion tracking module 122 may determine the bearing of the spectacles device 110 and/or 110′ in any of the manners described above. In other embodiments, the motion tracking module 122 may also determine the bearing of the spectacles device 110 and/or 110′ in another manner.

The information acquisition module 124 may acquire vehicle-related information from any suitable device, such as a vehicle sensor or other information acquisition system. For example, the information acquisition module 124 may obtain movement information of the vehicle from an Electronic Control Unit (ECU) of the vehicle, obtain speed information of the vehicle from a wheel sensor, obtain inclination information of the vehicle from an angle sensor etc. In addition, the information acquisition module 124 may further obtain the vehicle-related information through a network. As described above, the vehicle-related information may comprise vehicle status information, surrounding environment information, traffic information, route planning information, recommendation information, and prompt information. In other embodiments, the vehicle-related information may further comprise any other suitable information.

In an embodiment, the information acquisition module 124 may comprise at least one of an image capture module and a movement data acquisition apparatus, wherein the image capture module is used to obtain an image and the movement data acquisition apparatus is used to acquire data related to movement of the vehicle. The image capture module may be an image sensor and may obtain internal and/or external images of the vehicle. For example, in a case of obtaining an external image of the vehicle, the image capture module may be deployed at a desired position, such as in front of, behind, on the side of etc. of the vehicle. The image capture module may be an image sensor capable of obtaining an omnidirectional image or an image in a certain direction. The image obtained by the image capture module may be provided to the processing module 126 for processing or selection, and may, if appropriate, be provided to the spectacles device 110 and/or 110′ for display to the user.

The movement data acquisition apparatus may be connected to various data acquisition systems or modules of the vehicle (for example, an ECU, a vehicle sensor, etc.) to acquire the data related to the movement of the vehicle.

In addition, the information acquisition module may also obtain the vehicle-related information through a network (for example, the Internet) via the communication module 128.

As shown in FIG. 4, the processing module 126 may comprise components such as a circuit, which may implement audio, video, communication, navigation, logic functions and/or the like, and implement embodiments of the present disclosure, including, for example, one or more of the functions described herein. For example, the processing module 126 may comprise components for performing various functions, including, for example, one or more of the functions described herein, such as a digital signal processor, a microprocessor, various analog-to-digital converters, digital-to-analog converters, processing circuits and other support circuits. In addition, the processing module 126 may operate one or more software programs which may be stored in a memory, and the software programs may cause the processing module 126 to implement at least one embodiment, such as one or more of the functions described herein. In an embodiment, the processing module 126 may determine, from the information acquired by the information acquisition module 124, the information required to be provided to the spectacles device 110 and/or 110′ according to the bearing of the spectacles device 110 and/or 110′. For example, the processing module 126 may obtain the bearing of the spectacles device 110 and/or 110′ from the motion tracking module 122 and determine, from the information acquired by the information acquisition module 124, the information required to be provided to the spectacles device 110 and/or 110′ according to the bearing of the spectacles device 110 and/or 110′. By way of example, assuming that the bearing of the spectacles device 110 and/or 110′ is a direction in which the vehicle travels, the processing module 126 may determine that movement information of the vehicle (for example, a speed, a rotation rate, a gear etc.), traffic information and/or route planning information etc. are required to be provided to the spectacles device 110 and/or 110′ and provide the determined information to the spectacles device 110 and/or 110′. By way of example, assuming that the bearing of the spectacles device 110 and/or 110′ is a direction in which a building is located on one side of the vehicle and the vehicle is in a stationary state, the processing module 126 may determine that there is no need to provide the movement information of the vehicle to the spectacles device 110 and/or 110′ at this time, instead recommendation information related to the position where the vehicle is located, such as a hotel, a shopping mall, a playground, etc. is required to be provided to the spectacles device 110 and/or 110′, and the determined information is provided to the spectacles device 110 and/or 110′. By way of example, assuming that the bearing of the spectacles device 110 and/or 110′ is a direction in which a leg of the driver is located and this bearing occurring many times in a short period of time, the processing module 126 may determine that the driver may be in a fatigue driving condition, and prompt information related to fatigue driving may be provided to the spectacles device 110 and/or 110′ at this time.

In an embodiment, the image capture module of the vehicle body device 120 is capable of capturing an external image of the vehicle, and the processing module 126 may determine an external image of the vehicle corresponding to the bearing of the spectacles device 110 and/or 110′ as the information required to be provided to the spectacles device 110 and/or 110′ when the spectacles device 110 and/or 110′ is directed to an occlusion area. For example, when the spectacles device 110 and/or 110′ is directed to a vehicle body occlusion area such as an A/B post, a compartment cover, a vehicle door, a vehicle tail etc., the processing module 126 may determine that there is an occlusion area according to the bearing of the spectacles device 110 and/or 110′ determined by the motion tracking module 122, then determine an external image occluded by the occlusion area, select the occluded image from external images of the vehicle and transmit the occluded image to the spectacles device 110 and/or 110′. The spectacles device 110 and/or 110′ display the occluded image, so that the user can view the occluded image in the occlusion area to produce a perspective effect. In this embodiment, the visual angle of the user can be expanded, for example, to potentially avoid dangerous situations.

In an embodiment, the processing module 126 may determine the external image of the vehicle corresponding to the bearing of the spectacles device 110′ based on an image acquired by the image acquisition module 114 of the spectacles device 110′ and/or motion information detected by the motion detection module 116 of the spectacles device 110′. As an example, the processing module 126 may recognize an occluded object in the image acquired by the image acquisition module 114 through image recognition and determine the bearing of the spectacles device 110′ according to the motion information detected by the motion detection module 116, so as to determine the visual field of the spectacles device 110′ (or user) and the external image of the vehicle corresponding to the bearing of the spectacles device 110′, for example, an image area corresponding to the occluded object which should be extracted from the external image of the vehicle.

In an embodiment, the information processing module 126 may provide information related to an instruction from a user to the spectacles device 110 and/or 110′ based on the instruction. For example, the user may input a corresponding instruction in various input manners, such as voice input, button input, touch input, gesture input, gaze input etc. For example, if the user wishes to view information of traffic behind the vehicle, the user may instruct the information processing module 126 via a voice instruction to provide the information of the traffic behind the vehicle. In this case, the vehicle body device 120 may further comprise a voice recognition module for recognizing the voice instruction and providing the recognized voice instruction to the information processing module 126. After the information processing module 126 receives the voice instruction, it may provide corresponding information.

As shown in FIG. 4, the vehicle body device 120 may further comprise a communication module 128 which may transmit the determined information to the spectacles device 110 and/or 110′. In other embodiments, the communication module 128 may further receive information from the spectacles device 110 and/or 110′, such as the acquired image and/or motion information of the spectacles device 110 and/or 110′ etc. In addition, in other embodiments, the communication module 128 may further exchange information with a network.

In at least one example embodiment, the communication module 128 may comprise an antenna (or a plurality of antennas), a wired connector, and/or the like, which are operatively communicated with a transmitter and/or receiver. In at least one example embodiment, the processing module 126 may provide a signal to the transmitter and/or receive a signal from the receiver. The signal may comprise: signaling information, a user voice, received data, and/or the like according to communication interface standards. The communication module 128 may operate using one or more interface standards, communication protocols, modulation types, and access types. As an example, the communication module 128 may operate according to the following protocols: a cellular network communication protocol, a wireless local area network protocol (such as 802.11), a short distance wireless protocol (such as Bluetooth), and/or the like. The communication module 128 may operate in accordance with a wired protocol, such as Ethernet, car networking etc.

In addition, the vehicle body device 120 may further comprise a user interface for providing output and/or receiving input. The vehicle body device 120 may comprise an output device. The output device may comprise an audio output device such as a headset, a speaker, and/or the like. The output device may comprise a visual output device such as a display, an indicator light, and/or the like. The vehicle body device 120 may comprise an input device. The input device may comprise a microphone, a touch sensor, a button, a keypad, and/or the like. In an embodiment in which a touch display is included, the touch display may be configured to receive input through a single-touch operation, a multi-touch operation, and/or the like.

The present disclosure further provides a vehicle-mounted augmented method based on the same inventive concept as the spectacles device 110 and/or 110′ described above. The method may be performed by the spectacles device 110 and/or 110′. Description of the same parts as those of the foregoing embodiments is appropriately omitted.

FIG. 5 illustrates a flowchart of a vehicle-mounted augmented reality method 500 according to an embodiment of the present disclosure. The method 500 comprises, at block 501, receiving, at a spectacles device worn by a user, information which is determined based on bearing of the spectacles device from a vehicle body device; and at block 503, performing, at the spectacles device worn by the user, display or projection based on the received information.

In an embodiment, a left eye portion and/or a right eye portion of the spectacles device has a projection display module.

In an embodiment, the projection display module comprises a micro-LCoS display apparatus and a virtual image projection lens, and the method 500 further comprises: providing a stereoscopic image to a user in a case that both the left eye portion and the right eye portion of the spectacles device have the projection display module.

In an embodiment, the method 500 further comprises: acquiring an image for use by the vehicle body device; and detecting motion information of the spectacles device for use by the vehicle body device.

In an embodiment, the spectacles device may be powered by the vehicle body device.

In an embodiment, information associated with the bearing of the spectacles device comprises one or more of: vehicle status information; surrounding environment information; traffic information; route planning information; recommendation information; and prompt information.

The present disclosure further provides a vehicle-mounted augmented method based on the same inventive concept as the vehicle body device 120 described above. The method may be performed by the vehicle body device 120. Description of the same parts as those of the embodiment described above is appropriately omitted.

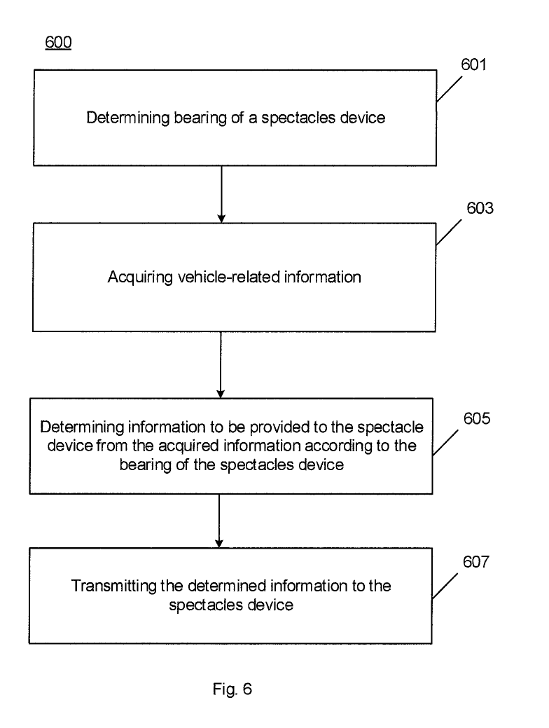

FIG. 6 illustrates a flowchart of a vehicle-mounted augmented reality method 600 according to an embodiment of the present disclosure. The method 600 comprises, at block 601, determining bearing of a spectacles device; at block 603, acquiring vehicle-related information; at block 605, determining information required to be provided to the spectacles device from the acquired information according to the bearing of the spectacles device; and at block 607, transmitting the determined information to the spectacles device.

In an embodiment, the spectacles device may be powered by the vehicle body device.

In an embodiment, acquiring vehicle-related information comprises: obtaining an image; acquiring data related to movement of a vehicle; and obtaining information related to the vehicle through a network.

In an embodiment, the obtained image comprises an external image of the vehicle, and the method 600 further comprises: determining an external image of the vehicle corresponding to the bearing of the spectacles device as the information required to be provided to the spectacles device when the spectacles device is directed to an occlusion area.

In an embodiment, determining the external image of the vehicle corresponding to the bearing of the spectacles device comprises: determining the external image of the vehicle corresponding to the bearing of the spectacles device based on the image acquired by the image acquisition module of the spectacles device and/or motion information detected by the motion detection module of the spectacles device.

In an embodiment, determining the bearing of the spectacles device comprises: determining the bearing of the spectacles device based on the obtained image of the spectacles device; determining the bearing of the spectacles device based on the obtained motion information of the spectacles device; or determining the bearing of the spectacles device based on the obtained motion information of the spectacles device and the obtained image of the spectacles device.

In an embodiment, the method 600 further comprises: providing information related to an instruction from a user and/or other devices to the spectacles device based on the instruction.

In an embodiment, the information provided to the spectacles device comprises one or more of vehicle status information; surrounding environment information; traffic information; route planning information; recommendation information; and prompt information.

Some of the embodiments of the systems, methods, and devices described above can achieve the following technical effects: space saving, no limitations on the visible area, and reduced weight. Other embodiments of the systems, methods, and devices described above can further provide a perspective display effect.

It is to be noted that any of the components of the apparatus described above may be implemented as hardware, software modules, or a combination thereof. In a case of the software modules, they may be included on a tangible computer-readable recordable storage medium. All software modules (or any of their subsets) may be on the same medium, or various software modules may be on different media. The software module may run on a hardware processor. The method steps are performed by using the different software modules running on the hardware processor.

In addition, one aspect of the present disclosure may use software running on a computing apparatus. Such implementations may use, for example, a processor, a memory, and an input/output interface. As used herein, the term “processor” is intended to encompass any processing device which may comprise a Central Processing Unit (CPU) and/or other forms of processing circuits. In addition, the word “processor” may refer to more than one processor. The word “memory” is intended to encompass a memory associated with a processor or CPU, such as a Random Access Memory (RAM), a Read Only Memory (ROM), a fixed memory (for example, a hard disk), a removable storage device (for example, a disk), a flash memory etc. A processor, a memory, and an input/output interface, such as a display and a keyboard, may be interconnected, for example, via a bus.

Therefore, computer software (which comprises instructions and codes for performing the method according to the present disclosure as described herein) may be stored in one or more of associated memory devices and, when ready to be used, is partially or fully loaded (for example, into a RAM) and executed by a CPU. Such software may comprise, but is not limited to, firmware, resident software, microcode, etc. The computer software may be computer software written in any programming language, and may be in a form of source codes, object codes, or intermediate codes between the source codes and the object codes, such as in a partially compiled form, or in any other desired form.

Embodiments of the present disclosure may take the form of a computer program product contained in a computer-readable medium having computer-readable program codes contained thereon. In addition, any combination of computer-readable media may be used. The computer-readable medium may be a computer-readable signal medium or a computer-readable storage medium. The computer-readable storage medium may be, but is not limited to, electrical, magnetic, electromagnetic, optical or other storage medium, and may be a removable medium or a medium that is fixedly mounted in the apparatus and device. Non-limiting examples of such computer-readable media are a RAM, a ROM, a hard disk, an optical disk, an optical fiber etc. The computer-readable medium may be, for example, a tangible medium such as a tangible storage medium.

The words used herein are for the purpose of describing particular embodiments only and are not intended to limit the embodiments. As used herein, the singular forms “a”, “an” and “the” mean that plural forms are also encompassed unless the context clearly dictates otherwise. It is also to be understood that when used herein, the words “comprising”, “having”, “including” and/or “include” refer to presence of features, numerals, steps, operations, elements and/or components as set forth herein, but do not preclude the presence or addition of one or more other features, numbers, steps, operations, elements, components, and/or combinations thereof.

It should also be noted that in some alternative implementations, the illustrated functions/actions may not occur in the order illustrated in the accompanying drawings. If desired, the different functions described in the present disclosure may be performed in a different order and/or concurrently with each other. In addition, one or more of the functions described above may be non-mandatory or may be combined, if desired.

While the embodiments of the present disclosure have been described above with reference to the accompanying drawings, it will be understood by those skilled in the art that the foregoing description is by way of example only and is not intended to limit the present disclosure. Various modifications and variations can be made to the embodiments of the present disclosure, and are also fall within the spirit and scope of the present disclosure, and the scope of the present disclosure is to be determined only by the appended claims.

I/We claim:

1. A vehicle-mounted augmented reality system comprising:
a spectacles device comprising:
a receiving module configured to receive information from a vehicle body device; and
a projection display module configured to project or display based on the received information; and
the vehicle body device comprising:
a motion tracking module configured to determine a position and/or orientation of the spectacles device;
an information acquisition module configured to acquire vehicle-related information;
a processing module configured to determine, from the acquired information, information to be provided to the spectacles device according to the position and/or orientation of the spectacles device; and
a communication module configured to transmit the determined information to the spectacles device.

2. The vehicle-mounted augmented reality system according to claim 1, wherein a left eye portion and/or a right eye portion of the spectacles device has the projection display module.

3. The vehicle-mounted augmented reality system according to claim 2, wherein the projection display module comprises a micro-Liquid Crystal on Silicon (LCoS) display apparatus and a virtual image projection lens, and the spectacles device is capable of providing a stereoscopic image to a user in a case where each of the left eye portion and the right eye portion of the spectacles device has the projection display module.

4. The vehicle-mounted augmented reality system according to claim 1, wherein the spectacles device further comprises at least one of:
an image acquisition module configured to acquire an image; and
a motion detection module configured to detect motion information of the spectacles device.

5. The vehicle-mounted augmented reality system according to claim 1, wherein the spectacles device is powered by the vehicle body device.

6. The vehicle-mounted augmented reality system according to claim 1, wherein the information acquisition module comprises at least one of:
an image capture module configured to capture an image, and
a movement data acquisition apparatus configured to acquire data related to operations of the vehicle,
wherein the information acquisition module is further configured to obtain the vehicle-related information from a network via the communication module.

7. The vehicle-mounted augmented reality system according to claim 6, wherein the image capture module is configured to be capable of capturing an external image of the vehicle, and the processing module is configured to determine an external image of the vehicle corresponding to the position and/or orientation of the spectacles device as the information to be provided to the spectacles device when the spectacles device is directed to an occlusion area.

8. The vehicle-mounted augmented reality system according to claim 7, wherein the processing module is configured to determine the external image of the vehicle corresponding to the position and/or orientation of the spectacles device based on an image acquired by the image acquisition module of the spectacles device and/or motion information detected by the motion detection module of the spectacles device.

9. The vehicle-mounted augmented reality system according to claim 8, wherein the motion tracking module is configured to determine the position and/or orientation of the spectacles device by one of:
the motion tracking module determining the position and/or orientation of the spectacles device based on the image of the spectacles device obtained from the image capture module; or
the motion tracking module determining the position and/or orientation of the spectacles device based on the motion information of the spectacles device received from the spectacles device; or
the motion tracking module determining the position and/or orientation of the spectacles device based on the motion information of the spectacles device received from the spectacles device and the image of the spectacles device obtained from the image capture module.

10. The vehicle-mounted augmented reality system according to claim 1, wherein the information processing module is configured to provide information related to a received instruction to the spectacles device based on the instruction.

11. The vehicle-mounted augmented reality system according to claim 1, wherein the information comprises one or more of:
vehicle status information;
surrounding environment information;
traffic information;
route planning information;
recommendation information; and
prompt information.

12. A vehicle-mounted augmented reality method comprising:
receiving, at a spectacles device, information which is determined based on a position and/or orientation of the spectacles device from a vehicle body device; and
performing, at the spectacles device, displaying or projection based on the received information.

13. A vehicle-mounted augmented reality spectacles device comprising:
a receiving module configured to receive, from a vehicle body device, information which is determined based on a position and/or orientation of the spectacles device; and
a projection display module configured to perform projection or displaying based on the received information.

14. A vehicle-mounted augmented reality method comprising:
determining, at a vehicle body device, a position and/or orientation of a spectacles device;
acquiring, at the vehicle body device, vehicle-related information;
determining, at the vehicle body device, information to be provided to the spectacles device from the acquired information according to the position and/or orientation of the spectacles device; and
transmitting, at the vehicle body device, the determined information to the spectacles device.

15. A vehicle-mounted augmented reality vehicle body device comprising:
a motion tracking module configured to determine a position and/or orientation of a spectacles device;
an information acquisition module configured to acquire vehicle-related information;
a processing module configured to determine, from the acquired information, information to be provided to the spectacles device according to the position and/or orientation of the spectacles device; and
a communication module configured to transmit the determined information to the spectacles device.
